(19) United States
(12) Patent Application Publication
(10) Pub. No.: US 2010/0238289 A1
(43) Pub. Date: Sep. 23, 2010

(54) IN-CAR AUDIO/VIDEO RECORDING REARVIEW MIRROR ASSEMBLY

(76) Inventor: Chih-Hsien WU, Taipei City (TW)

Correspondence Address: LEONG C LEI, PMB # 1008, 1867 YGNACIO VALLEY ROAD, WALNUT CREEK, CA, 94598, US

(21) Appl. No.: 12/408,736

(22) Filed: Mar. 23, 2009

(51) Int. Cl. H04N 7/18; H04N 5/225; H04N 5/76

(52) U.S. Cl. 348/148; 348/373; 348/E05.024; 348/E07.085; 348/231.7

(57) ABSTRACT

An in-car audio/video recording rearview mirror assembly is provided for recording the behaviors of the driver and passengers inside a car. The in-car audio/video recording rearview mirror assembly includes a rearview mirror enclosure and a digital monitoring system. The digital monitoring system is set inside the rearview mirror enclosure, which is attached to an in-car rearview mirror or a fixture, in such a way that a monitor camera device may receive image and sound from inside the car through the mirror for recording the video and audio data occurring inside the car for all the time.

### (a) TECHNICAL FIELD OF THE INVENTION

The present invention generally relates to an in-car audio/video recording rearview mirror assembly, and particularly to a monitoring system that arranges a digital monitor host device inside a rearview mirror to record the image and sound of events occurring inside for all the time in order to provide evidences showing the true process of the event for protecting the driver and the passengers for situations of for example dispute between the driver and the passengers, the driver being attacked, or robbery, and to carry out photography for evidences in a secret manner so as to avoid making the persons who are photographed uncomfortable.

### (b) DESCRIPTION OF THE PRIOR ART

In the modern society, service provided by using automobiles as a measure of transportation takes a great percentage of the industry of the society. A cab or an internal space of an automobile is a private and closed space between the driver of the automobile and the passengers. For many events occurring inside a car due to for example misconduct behavior of the driver, unexpected dispute between the driver and the passengers, the driver being attacked or robbed, it often lacks of third-party eyewitness due to the fact that the driver and the passengers are located in a closed and private space, and any mechanism attempting to solve the dispute can only rely on the testimonies provided by the opposite parties, which are often contradictory and in compatible with each other, whereby the final determination or judgment cannot be properly made. Due to such a situation, distrust becomes a problem often occurring between the driver and the passengers, deteriorating the quality of service. Further, for events that the driver is attacked or robbed, it is often hard to identify and hunt down the criminals due to lacking of photos of the criminals and it is hard to sue the criminals due to lacking of evidence even the criminals have been hunted down. Thus, the present invention aims to provide an in-car audio/video recoding rearview mirror assembly that is capable to completely record all the events occurring inside a car to provide a full understanding of the course or process of the events and thus showing evidences for opposite parties involved in the events.

Currently, various multi-function digital monitor systems are available in the market, but there is no in-car audio/video monitor system dedicated for in-automobile use. Many persons attempt to install the regular cameras and monitor hosts above the dash board of a car to record the images and sounds during the movement of the car. However, various parts and accessories are necessary for installing a camera and a monitor host and such parts and accessories and the related cables often make the interior spaced very disordered and unorganized. Further, installing the monitor host on the dash board often interferes with the eyesight of the driver, leading to potential risk of traffic accidents. Vibrations and shocks induced by the movement of the car may also deteriorate the quality of image so recorded. In addition, for any person knowing the installation of the monitor host inside the car, he or she may remove or damage the monitor host to destroy the evidence so recorded after committing a criminal.

Further, most of the digital monitor systems available in the market require sufficient lighting for taking pictures. Thus, photographing equipment must be of night vision function in order to take clear picture in a dark environment, passing through a tunnel, or in the nighttime.

In view of these problems, the present invention aims to solve the above discussed drawbacks by providing an in-car audio/video recording rearview mirror assembly, which arranges a digital monitor host inside a rearview mirror to effect photographing from a relatively high location inside a car so as to obtain excellent range of viewing angle. When a camera of the monitor host is set toward the interior of the car, images and sounds generating inside the car can be properly taken and recorded. Since the device is installed at a relatively high location, it does not interfere with the eyesight of the driver, and since it is concealed behind the rearview mirror, a criminal cannot find out where and how the monitor host is installed. In case of any concern of privacy, a reminder poster or sticker can be set inside the car to remind the passengers, of course without indication where the device is installed, or alternatively the recorded image and sound are enciphered and can only be deciphered by authorized persons or organizations so as to ensure that the recorded data can only be reviewed and accessed by the authorized persons and organizations.

### SUMMARY OF THE INVENTION

A primary objective of the present invention is to provide an in-car audio/video recording rearview mirror, which arranges a concealed digital monitoring system inside a rearview mirror whereby with the completely concealed digital monitoring system, changes occurring inside the car can be recorded for all the time, by which the driver is forced to conduct properly and politely and legal protection can be ensured in events of disputes between the drivers and passengers, or to represent proper evidence for attack or robbery happening to the driver.

Another objective of the present invention is to provide an in-car audio/video recording rearview mirror assembly, which comprises an output interface for connection with a display device for direct inspection of the recorded images and sounds.

To achieve the above objectives, in accordance with the present invention, an in-car audio/video recording rearview mirror assembly is provided, comprising a concealed digital monitoring system arranged inside an enclosure of a rearview mirror. The rearview mirror has a special mirror surface to allow the digital monitoring system arranged inside the rearview mirror enclosure to directly record audio/video changes occurring inside the car through the mirror surface, but the driver and passengers inside the car cannot see the digital monitoring system through the mirror surface, so that photographing can be performed in a completely concealed and unrecognizable manner, avoiding the possible mental pressure imposed to the passengers. The contents of recording may later be used as evidence for resolving dispute occurring inside the car. The in-car audio/video recording rearview mirror may also be provided with one or more infrared emitters to supplement light for situation of insufficient lighting, so as to overcome the constraint imposed to the photographing operation by insufficiency of lighting.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a front-side perspective view of the present invention in an assembled form.

FIG. 3 is a rear-side perspective view of the present invention in the assembled form.

FIG. 4 is a perspective view illustrating the insertion of a memory card in accordance with the present invention.

FIG. 5 is a perspective view illustrating spatial arrangement between clasps and a sprig in accordance with the present invention.

FIG. 6 is a schematic view illustrating the present invention attached to an in-car rearview mirror.

FIG. 7 is a schematic view illustrating the operation of a digital system in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

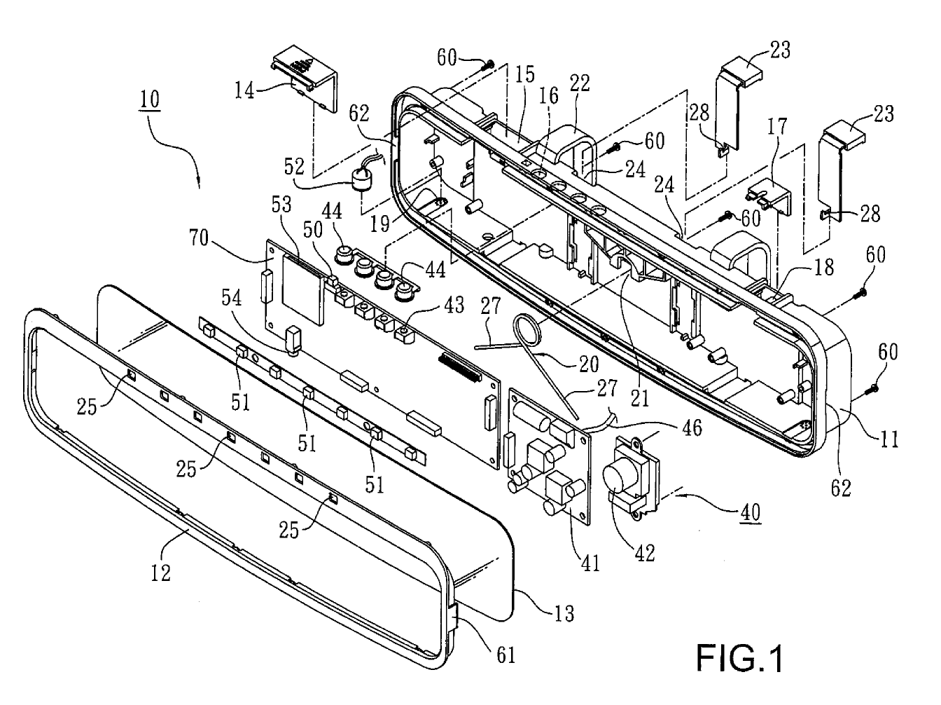

Referring to the drawings and in particular to FIGS. 1-4, the present invention provides an in car-audio/video recording rearview mirror assembly, comprising a rearview mirror 10, a CMOS (complementary metal-oxide semiconductor) module, and a digital monitoring system 40. The digital monitoring system 40, which is made a concealed system, is arranged in an interior space of the rearview mirror 10 in such a way that a photographing camera 42 may take an image inside a car in which the review mirror assembly is mounted through a plastic-panel mirror surface 13.

The rearview mirror 10 comprises a rearview mirror enclosure 11, a mirror frame 12, and a mirror surface 13. The enclosure 11 comprises a memory card slot lid 14, a memory card receiving opening 15, pushbutton openings 16, a power cable slot lid 17, a power cable receiving opening 18, a sound recording hole 19, a spring 20, a spring retention notch 21, reinforcing retention frames 22, clasps 23, and clasp chutes 24. The mirror frame 12 forms a plurality of infrared emitter accommodation openings 25.

The concealed digital monitoring system 40 comprises an integrated circuit 41, a photographing camera 42, a plurality of function switches 43, pushbuttons 44, a sound recording switch 50, infrared emitters 51, a microphone 52, a memory card slot 53, and an audio/video (AV) output terminal 54.

To assemble, the infrared emitters 51 are disposed in the infrared emitter accommodation openings 25 of the mirror frame 12, and the infrared emitters 51 automatically supplement light in the nighttime, passing through a tunnel, or other lighting insufficiency conditions, in order to prevent deterioration of quality of images taken due to insufficiency of lighting. The mirror 13 is fit to a stepped flange on the back of the mirror frame 12 to complete a front portion of the rearview mirror 10.

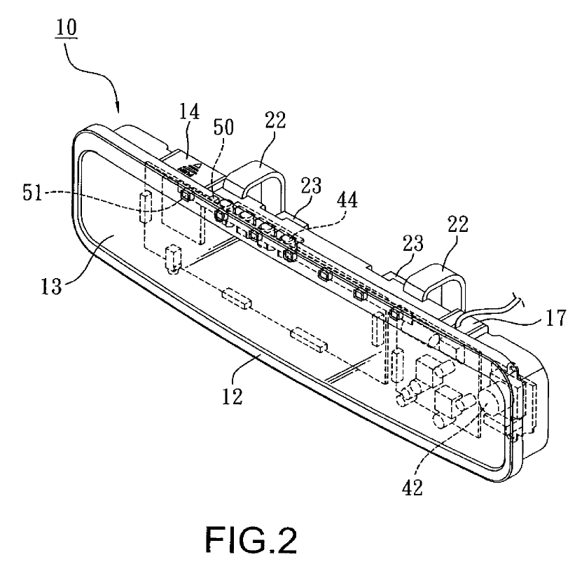

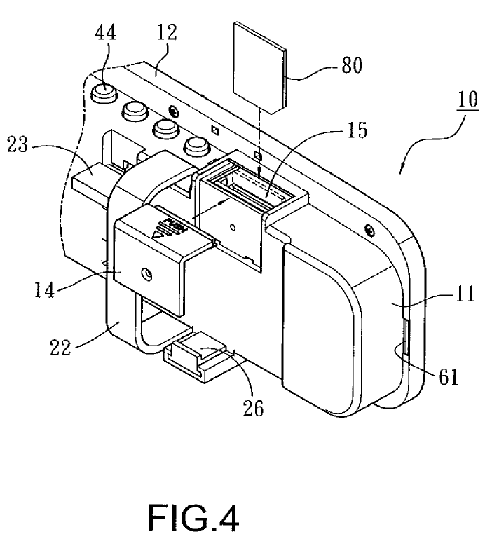

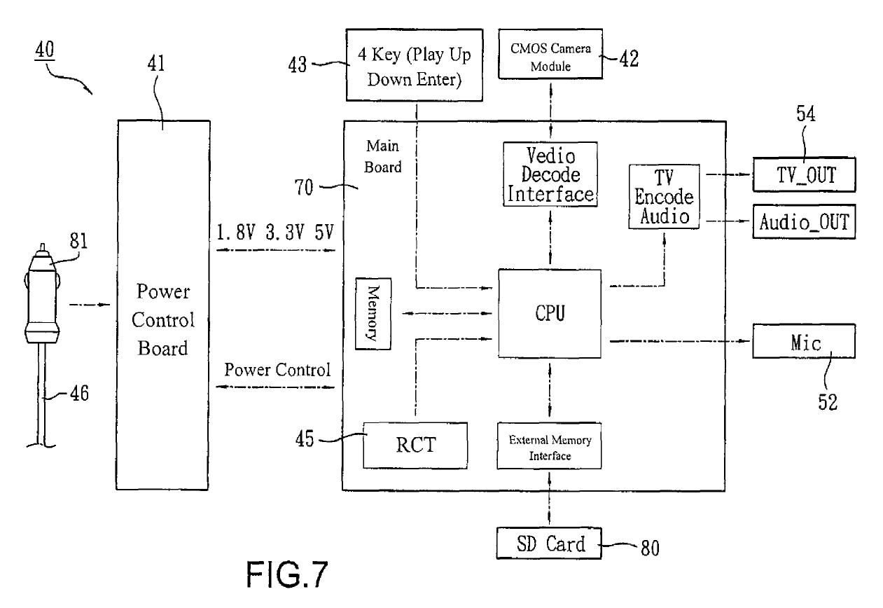

The concealed digital monitoring system 40 is structured to allow the camera 42 thereof to be secured inside the rearview mirror enclosure 11 by screws/bolts and connected to the camera 42 and the integrated circuit 41, as well as a control circuit board 70, through data transmission cables. The control circuit board 70 is provided with the sound recording switch 50, the function switches 43, which offers respectively four functions of D1 MENU, D2:UP, D3:DOWN, and D4:ENTER. The function switches 43 are respectively provided with the pushbuttons 44 on the tops thereof to allow a user to actuate the function switches 43 from outside the rearview mirror assembly 11. The concealed digital monitoring system 40 so assembled is secured inside the rearview mirror enclosure by screws/bolts in order to protect the digital monitoring system from undesired external impact, which may cause displacement and damage, when the car is in movement. The rearview mirror enclosure 11 has a bottom that forms the sound recording hole 19 and the microphone 52 of the digital monitoring system 40 is set above the sound recording hole 19, whereby any sound produced inside the car can be transmitted to the microphone 52 through the sound recording hole 19 and thus the sound inside the car can be received and recorded. The function switches 43 that are provided with the pushbuttons 44 and the sound recording switch 50 can be operated by the user to select the desired functions by directly actuating the function switches 43 from the outside and to determine if to make record of sound by directly switching on/off the sound recording switch 50. The memory card slot 53 is set within the memory card receiving opening 15 in such a way that an external memory card 80 can be inserted into the memory card slot 53 through the memory card receiving opening 15 and with the external memory card 80, the available time of recording can be extended (as shown in FIG. 4). The memory card slot lid 14 can then be fit to the memory card receiving opening 15 to prevent entry of dust and debris that may cause undesired damage to the related circuit. The digital monitoring system 40 comprises a power cable 46, which extends through the power cable receiving opening 18 and is protected against dust and debris by the power cable slot lid 17 fit to the power cable receiving opening 18 (as shown in FIG. 2), for plugging into a cigarette lighter socket 81 provided inside the car (as shown in FIG. 7) to supplement electrical power, whereby long term continuous recording of video data can be realized. The spring 20 is set in the spring retention notch 21 and has two legs 27 respectively fit into notches 28 defined in lower ends of the clasps 23 so as to respectively mount the two clasps 23 in the two clasp chutes 24 that are formed on the back side of the rearview mirror enclosure 11 and also to provide the vertical clamping function to the clasps 23. After all the components are received and set inside the rearview mirror enclosure 11, the mirror frame 12 is then fixed by having resilient tenons 61 formed thereon engaging mortise slots 62 defined in opposite side walls of the rearview mirror enclosure 11 and using screws/bolts 60 to insert from the back side of the rearview mirror enclosure 11 and tighten to the mirror frame 12. Video data recorded by the digital monitoring system 40 can be displayed on an external liquid crystal display through an external AV cable connected to the AV output terminal 54 on the lower edge of the control circuit board 70. Preferably, the video data so recorded is in a read-only format so that modification of the video data cannot be carried out.

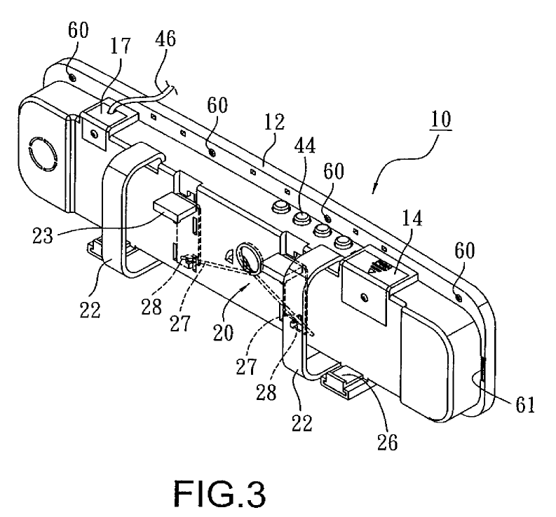

Referring to FIG. 3, the lower edge of the backside of the rearview mirror enclosure 11 forms a clamp hook 26 and the clasps 23 are also arranged on the backside of the rearview mirror enclosure 11 by being retained by the spring 20. The notches 28 defined in the lower ends of the clasps 23 are set in engagement with the spring 20. By moving the clasps 23 up and down to cooperate with the 26 to effect clamping, a clamping space A defined therebetween can be adjustable to be fit to various specifications of an in-car rearview mirror or a fixture inside the car. Further, the backside of the rearview mirror enclosure 11 is provided with the reinforcing retention frames 22 for more securely attaching to the in-car rearview mirror and preventing the rearview mirror 10 of the present invention from falling due to undesired impact occurring in the movement of the car.

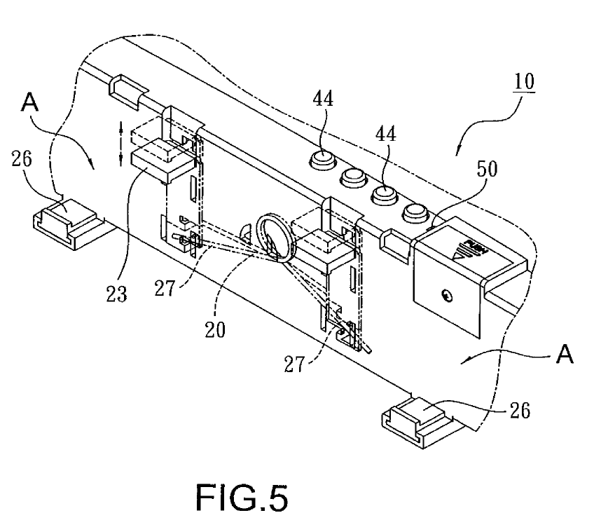

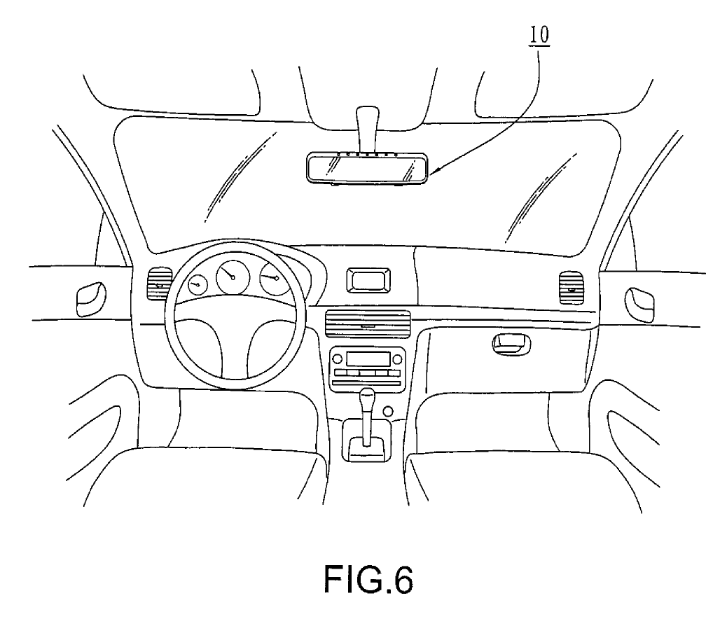

Referring to FIGS. 5 and 6, to mount the present invention to an in-car rearview mirror, the clasps 23 of the rearview mirror 10 are first moved upward to allow the rearview mirror 10 to fit onto the in-car rearview mirror so as to have the in-car rearview mirror located between the clamp hook 26 and the clasps 23. The clasps 23 that have been moved upward are then released and the spring 20 connected to the clasps 23 may induce a returning force to drive the clasps 23 back to clamp the in-car rearview mirror, whereby the rearview mirror 10 of the present invention can be fixed to the in-car rearview mirror (as shown in FIG. 6).

Referring to FIG. 7, the digital monitoring system 40 comprises a CMOS camera 42. CMOS is a semiconductor that records the variation of light in digital photograph data. The CMOS module is connected to an external screen and can be operated to change the settings thereof at the first time of use. The digital monitoring system 40 can be set via the CMOS module, such as the functions of time, language, memory card, image displaying, and image deleting, which are realized through input via the four function switches 43. The digital monitoring system is provided with an RCT time register 45 (as shown in FIG. 7) for recording the time of each segment of video image so recorded and the recording time after the car engine is shut down. This helps improving efficiency for later searching of the video image. The digital monitoring system 40 can be configured to record the video image and sound in an internal memory thereof, or to transmit the recorded contents through the AV transmission cable for storage in an external SD card. The image stored in the memory card 80 can be displayed with image displaying software or can be directly displayed through the CMOS module. The digital monitoring system can be charged by properly converting the car electrical system through a power supply device, whereby the digital monitoring system can realize automatic recharge during the operation of the car without frequent detachment for charging with external charging device and the digital monitoring system can be set in full scale of power supply during the operation thereof in order to ensure continuous recording of video and audio data.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An in-car audio/video recording rearview mirror assembly comprising a rearview mirror, a CMOS (complementary metal-oxide semiconductor) module, and a digital monitoring system, wherein:
the rearview mirror comprises a rearview mirror enclosure, a mirror frame, and a mirror; the enclosure comprises a memory card slot lid, a memory card receiving opening, pushbutton openings, a power cable slot lid, a power cable receiving opening, a sound recording hole, a spring, a spring retention notch; infrared emitters are disposed in infrared emitter accommodation openings defined in the mirror frame and are located behind the mirror, a clamp hook is formed at a lower edge of a backside of the rearview mirror enclosure; data transmission cables are set in the rearview mirror enclosure to connect a camera, an integrated circuit, and a control circuit board, the control circuit board being provided with a sound recording switch, function switches, a memory card slot, and a microphone,
the CMOS module is connected to an external display; and
the digital monitoring system comprises the camera, the integrated circuit, a memory card, the microphone, and the infrared emitters.

2. The in-car audio/video recording rearview mirror assembly according to claim 1, wherein reinforcing retention frames are provided on a backside of the rearview mirror assembly.

3. The in-car audio/video recording rearview mirror assembly according to claim 1, wherein the mirror frame forms a plurality of infrared emitter accommodation openings in an upper portion thereof.

4. The in-car audio/video recording rearview mirror assembly according to claim 1, wherein the clasps define notches in lower ends thereof and the clasps are set in clasp chutes formed on a backside of the rearview mirror enclosure.
